(19) United States
(12) Patent Application Publication
(10) Pub. No.: US 2026/0133072 A1
(43) Pub. Date: May 14, 2026

(54) METHOD AND SYSTEM FOR MEASURING THE SETTING TIME OF A GYPSUM BOARD

(71) Applicant: SAINT-GOBAIN PLACO, COURBEVOIE (FR)

(72) Inventors: Jeanne LOUREAU, COURBEVOIE (FR); Benoit MONTIGNY, COURBEVOIE (FR); Jiri HANAK, AUSSEE (AT); Martina HESSOVA, PRAGUE (CZ); Matthias SCHROEDER, DÜSSELDORF (DE)

(21) Appl. No.: 19/120,083

(22) PCT Filed: Oct. 11, 2023
(86) PCT No.: PCT/EP2023/078217

§ 371 Date: Apr. 10, 2025

(30) Foreign Application Priority Data
Oct. 13, 2022 (EP) 22201405.2

(51) Int. Cl. G01J 5/48; B28B 17/00; B28B 19/00; G01N 25/20

(52) U.S. Cl. CPC G01J 5/485; B28B 17/0036; B28B 17/0081; B28B 19/0092; G01N 25/20

(57) ABSTRACT

A computer implemented method for in-line, real-time monitoring of the time-temperature profile of a continuously produced gypsum board in a gypsum board manufacturing line. The method takes as input the signals of a series of infrared sensors placed at given distances along the gypsum board manufacturing line between the moulding stage and the cutting stage of the gypsum board manufacturing line, and further takes as input the speed of the continuously produced gypsum board on the gypsum board manufacturing line. The method provides as output a corrected time-temperature profile of the continuously produced gypsum board. The method includes converting the signals of the series of infrared sensors into a time-temperature profile based on the speed of the continuously produced gypsum board on the gypsum board manufacturing line; processing the time-temperature profile through a correlation model and/or a physical model P-M to calculate a corrected time-temperature profile.

### TECHNICAL FIELD

The present invention pertains to a method and a system for real-time and in-line monitoring of the setting time-temperature profile of a continuously produced gypsum board.

### TECHNICAL BACKGROUND

Gypsum boards, for wall and ceiling systems, are well-known applications of gypsum, calcium sulphate dihydrate CaSO₄ 2(H₂O). They are made of a gypsum core sandwiched between two cover sheets which are usually paper based sheets.

The base material from which gypsum crystal matrix of the gypsum core is made is calcium sulphate hemihydrate CaSO₄ 0.5(H₂O), also named ‘stucco’, which is produced by dehydration or calcination of gypsum CaSO₄ 2(H₂O) to remove 1.5 molecules of water.

In common industrial manufacturing lines, calcinated calcium sulphate hemihydrate, called stucco, is fed to a holding bin wherein water is added to the stucco to form a slurry. Foam may also be added, and/or air blown into the slurry to form pores. Once ready, the slurry is poured between two large rolls of cover sheets, e.g., paper-based sheets, and cast into a single continuous board which is the precursor to individual gypsum boards.

The continuous board is thereafter conveyed to a cutting station while the stucco is hydrating and hardening before ultimately being cut by a cutting blade into individual gypsum boards of various lengths. The hardening time, also named setting time, of the continuous board is a critical parameter in the manufacturing process.

It is mandatory to have the slurry in the continuously produced gypsum board be set enough before the cutting step. A board which has not had enough time to stiffen may be too soft for a clean cut. It may sag at the cutting stage and/or may be torn, mashed, or shredded by the cutting blade, e.g., a knife blade. On the other hand, a continuous board which is completely hardened may be too strong for the cutting blade and may break or crack upon cutting. Such shortcomings may cause production breakdowns.

The setting time of the continuous board varies upon several parameters, e.g., the chemical composition of the board (e.g., nature of the stucco, water content, accelerator, other additives, foam), the thickness and/or the thermal conductivity of the slurry and/or cover sheets, the humidity and/or temperature of the surrounding environment.

As a matter of fact, the conveyor speed and/or the drying power or time should be adjusted to ensure that the continuously produced gypsum board shows the convenient strength or stiffness when it reaches the cutting stage for a clean cut. Otherwise, the cutting stage may need to be postponed or advanced until or before the continuous board has set or stiffened enough. The speed at which the conveyor is running may need to be reduced or increased. In the first case where the continuous board is not set enough, the production rate of gypsum boards may drop. In the second case where the continuous board is too hard, risk of breakage of the board may increase.

The ASTM C 472 standard provides two different definitions of the setting time: the Vicat set and, as the setting of the slurry is an exothermic hydration reaction, the Temperature Rise Set (TRS).

Regarding the Vicat set, the ASTM C 472 standard discloses a method to measure it with a penetrating needle falling into a slurry. The setting time is considered as complete when the needle no longer penetrates the slurry. However, the setting time does not determine the time of complete hydration of gypsum.

Regarding the Temperature Rise Set (TRS), the ASTM C 472 standard also discloses a method to measure it by monitoring the temperature of slurry in an insulated block. The setting time is the elapsed time from the time when water was first added to gypsum to the time when the maximum temperature rise is attained. The measured setting time is assumed to correspond to the hydration time of the slurry.

A common practice in manufacturing lines is to perform ex-situ measurements of the setting time, either the Vicat set and/or the temperature rise set (TRS), on samples collected from the manufacturing line.

U.S. Pat. No. 4,496,515 A [UNITED STATES GYPSUM CO [US]] 29 Jan. 1985 discloses a method for cutting a continuous gypsum board wherein said continuous board is cut with a fluid having high pressure and high velocity, i.e., a water or oil blade, just after the initial stiffening and before the temperature rise set or setting time, also named Vicat set. The use of a high pressure and high velocity fluid for cutting instead of knife blades allows to cut softer board and circumvent the aforesaid drawbacks in using knife blades.

US2004052297 A1 [RAYTEK [US]] 18 Mar. 2004 describes a system and a method for real-time in-line monitoring the temperatures of a slurry in a continuously produced gypsum board at different locations. A time-temperature is recorded by a series of infrared sensors positioned along the gypsum board between the moulding stage and the cutting stage and displayed to an operator. An algorithm may be further implemented to compensate changes in ambient air temperature through the product of a compensation variable, provided by an operator, and the difference between temperature measured by the infrared sensors and the measured ambient air temperature.

WO 2017078952 A1 [UNITED STATES GYPSUM CO [US]] 11 May 2017 discloses a system and a method for monitoring the set of a slurry in a continuously produced gypsum board by measuring the relative sag height of a continuously produced gypsum board over an unsupported span within a conveyor. The measured relative sag height is correlated to a percent of hydration of the slurry.

CN 110757645 A [BEIJING NEW BUILDING MAT PLC] 7 Feb. 2020 discloses a method for measuring the setting time of a sampled slurry upon hydration wherein the temperature of the slurry is recorded over time, and the initial and final setting times are measured from the time-temperature curve through a tangent method.

US2017363524 A1 [UNITED STATES GYPSUM CO [US]] 9 Jun. 2020 discloses a method and a system based on in-line measurement with a force gauge of the setting time of a slurry on the manufacturing line. The force gauge measures the resistance force upon a gypsum board along its normal axis.

The measured resistance force is then correlated to the compressive strength and the percentage of hydration of the from a mapping between recorded resistance data and a database containing values of percent hydration determined from temperature rise set (TRS) data or Vicat set data coming from ex-situ measurements on collected samples according to the ASTM C 472 standard.

The system may also further rely on an in-line, continuous, and real-time temperature rise monitoring system comprising a series of infrared sensors along the manufacturing line, and on a processor configured to generate a time-temperature curve and to store the time-temperature data into a database. The database is then used as a basis for further correlation between the measured resistance force and the values of percent hydration derived from the time-temperature data.

### SUMMARY OF THE INVENTION

### Technical Problem

One drawback of the common practice consisting in performing ex-situ measurement on samples collected from the manufacturing line is that it requires too much time. Production breakdowns at the cutting stage cannot be avoided during the measurement. Moreover, a real-time feedback control may be difficult to implement based on this ex-situ time-consuming practice.

Methods relying on in-line contact sensors such as a force gauge to measure the strength of a slurry in the manufacturing lines requires the installation of additional mechanical sensors onto said manufacturing lines. Not only may additional costs be incurred, but also further calibration based on ex-situ common measurements of TRS and Vicat set is required for the in-line mechanical measurements to be representative of the setting time or hydration time of the slurry.

Further, contact measurements may be very challenging at high line speeds and/or for lightweight gypsum board as they may be a source of surface defects because of direct contact with the continuous board surface.

On the other hand, a real-time in-line monitoring system comprising a series of infrared sensors along the manufacturing line before the cutting stage may also be used as a support for the calibration of a mechanical sensors through a TRS/mechanical resistance correlation.

However, the temperature profiles derived from the infrared sensors may be too noisy and show varying offsets comparing to the ex-situ TRS measurement. These discrepancies may be due to, e.g., variations of the temperature of the ambient air surrounding the manufacturing lines, to changes in the heat capacity or the thickness of the board (coming from, e.g., the water content or the nature of the cover sheets), and/or to inherent drifts and/or inaccuracies of the infrared sensors.

As infrared sensors are usually placed before the cutting stage and the cutting step is performed before the continuous board reaches its full stiffness or strength, another drawback of the current use of infrared sensors along the manufacturing line is that only part of the setting time-temperature profile or curve is acquired, i.e., only part of the curve before the maximum temperature plateau. The remaining time-temperature profile or curve may be interpolated but the interpolation may often be misled because of the lack of data, in particular around the inflexion point of the time-temperature curve. Therefore, inaccurate estimations of the setting time may occur.

Thus, there is a need for a simple method and system which allows the real-time and in-line monitoring of the setting time-temperature profile of a continuously produced gypsum board while also being suited to high production throughputs and not perturbing the gypsum board in its hardening/stiffening stage.

### Solution to the Technical Problem

The aforementioned technical problem is solved by the invention as described in claims.

In a first aspect of the invention, there is provided a method for in-line, real-time monitoring of the time-temperature profile of a continuously produced gypsum board in a gypsum board manufacturing line.

In second and third aspects of the invention, there is provided a data processing system comprising means for carrying out a method according to the first aspect of the invention, and a computer program comprising instructions which, when the program is executed by a computer, causes the computer to carry out a method according to the first aspect of the invention.

In a fourth aspect of the invention, there is provided a system implementing the method according to the first aspect of the invention.

In a fifth aspect of the invention, there is provided a feedback control system for the hydration of a continuously produced gypsum board in a manufacturing line of a gypsum board.

### Advantages of the Invention

A first advantage is that the invention eliminates discrepancies between the temperature signals from the infrared sensors and the true temperature data that may be derived from ex-situ TRS measurements. The time-temperature monitored according to the invention is more accurate and more reliable.

Furthermore, as a second advantage, the risk of false or misled interpolation of the non-acquired part of the time-temperature profile is reduced or even eliminated.

A third advantage is that the invention does not rely on contact measurement and so the risk of surface defects is eliminated.

A fourth advantage of the invention is that it may be easily implemented on existing manufacturing lines at minimal costs.

As a fifth advantage, the method and the system according to the invention may be implemented as part of a feedback control system for the hydration of a continuously produced gypsum board.

### BRIEF DESCRIPTION OF DRAWINGS

FIG. 1 is schematic representation of a gypsum board manufacturing line equipped with a system according to the second aspect of the invention.

FIG. 2 is a schematic representation of a detail I of the gypsum board manufacturing line of [FIG. 1] between the moulding stage and the cutting stage.

FIG. 3 is a plot of examples of time-temperature curves generated from measures by a series of infrared sensors along a manufacturing line and from a Temperature Rise Set (TRS).

FIG. 4 is a plot of examples of time-temperature signals of infrared sensors at their respective location along a manufacturing line.

FIG. 5 is a data flow diagram of a computer implemented classification method according to the first aspect of the invention.

FIG. 6 is a physical data flow diagram of a processing data system to implement a method according to the first aspect of the invention.

FIG. 7 is a plot of an acquired time-temperature profile according to an example embodiment.

FIG. 8 is a plot of a time-temperature profile from TRS, and a parametrized fitting sigmoid function and its first derivative as a fitting model for an acquired time-temperature profile according to an example embodiment.

FIG. 9 is a plot of a corrected time-temperature profile, a corrected parametrized fitting sigmoid function and their corrected first derivatives according to an example embodiment.

FIG. 10 is a plot of targeted hydration time compared to a corrected first derivative of an acquired time-temperature profile according to an example embodiment.

### DETAILED DESCRIPTION OF EMBODIMENTS

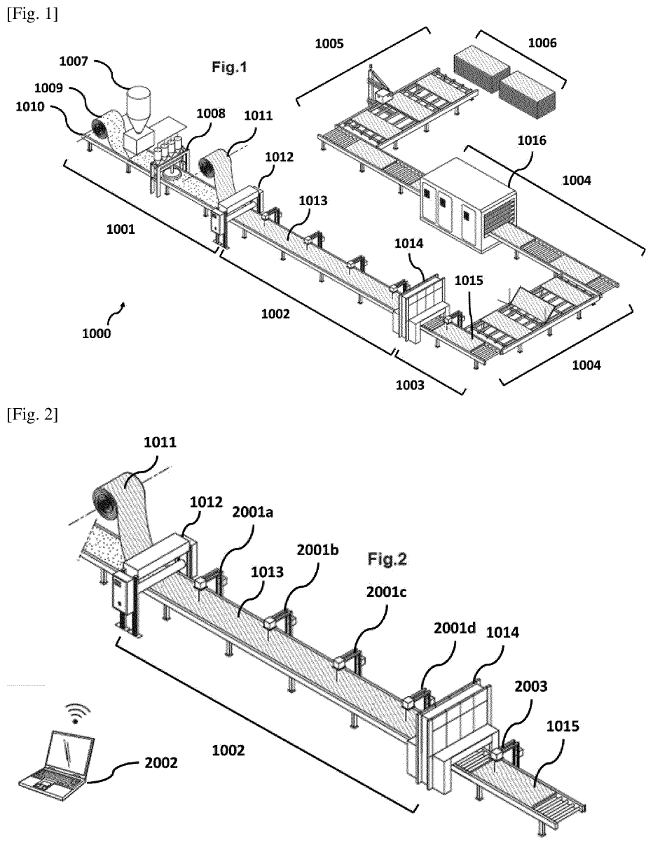

With reference to [FIG. 1], a common industrial manufacturing line 1000 of gypsum boards comprises a forming or moulding stage 1001, a setting or hardening stage 1002, a cutting stage 1003, a drying stage 1004, a controlling stage 1005, a stacking and packaging stage 1006.

At the forming or moulding time 1001, a calcinated calcium sulphate hemihydrate, called stucco, is fed to a holding bin 1007 wherein water is added to the stucco to form a slurry. Foaming agents and other additives, e.g., setting accelerator, may also be added in the bin 1007. Air may also be blown into the slurry.

Once ready, the slurry is poured through a series of nozzles 1008 onto a bottom cover sheet 1009, e.g., paper sheet, which is unrolled onto a conveyor belt 1010. Then, a top cover sheet 1011, e.g., paper sheet, is unrolled onto the slurry and the sandwiched slurry is conveyed between rollers 1012 (the extruder) which define the thickness of the single continuously produced board 1013.

At the setting or hardening stage 1002, the continuously produced board is conveyed a given distance at a given speed to provide time for the setting or hardening reaction to occur within the slurry before the board reaches the cutting station 1014 at the cutting stage 1003, where it is ultimately cut into single pieces 1015 of gypsum boards with various lengths by a cutting blade.

During the drying stage 1004, the single or individual pieces of boards are flipped and continuously conveyed to a dryer 1016. At the exit of the dryer 1016, the pieces are inspected at the controlling stage 1005, arranged into stacks, and packaged at the stacking and packaging stage 1006 before being stored and/or shipped to clients.

As explained earlier, for a clean cut of the continuously produced board 1013 at the cutting station 1004, the slurry must be set or hardened enough to prevent the board from sagging, mashing or shredding if too soft, or cracking or breaking if too hard upon cutting.

The time required for the slurry to set or harden may depend upon several parameters, e.g., the chemical composition of the board (e.g., nature of the stucco, water content, accelerator, other additives, foams), the thickness and/or the thermal conductivity of the slurry and/or cover sheets, the humidity and/or temperature of the surrounding environment.

It is a common practice to adjust the speed of the manufacturing line (i.e., the speed of the conveyor 1010) to provide enough time for the slurry to set or harden enough for the continuously produced gypsum board 1013 to have the required strength or stiffness when it reaches the cutting stage for a clean cut.

The time required for a complete setting or hardening of a slurry, hereafter named the setting time, may be interpreted as the setting time as defined by the ASTM C 472 standard in the context of the Temperature Rise Set (TRS), i.e., the elapsed time from the time when water was first added to gypsum to the time when the maximum temperature rise is attained.

However, the time when the continuously produced gypsum board 1013 may have the required stiffness or strength for a clean cut at the cutting station 1014 may be shorter than the setting time defined in the ASTM C 472 depending on the components e.g., nature and/or thickness of the cover sheets and/or slurry, of the continuously produced gypsum board. Nevertheless, cases may be seen where the stiffening time may correspond to the setting time or be a little higher.

Therefore, in the context of the present disclosure, the time to be considered regarding the setting or hardening of the slurry during the setting or hardening stage 1002 may be either the stiffening time or the setting time. It is thereafter named ‘hydration time’.

As exemplified on [FIG. 2], which is a detailed representation of the setting or hardening stage 1002 of the manufacturing line 1000 depicted on [FIG. 1], the manufacturing line may be provided with a series of infrared sensors 2001a-d for an in-line, real-time measurement of the temperature of the continuously produced gypsum board 1013. Examples of infrared sensors may be IRT C.03-K-80F 27C sensors manufactured by EXERGEN®.

The infrared sensors 2001a-d may send their temperature related signals through a wired or wireless connection to a data processing system, e.g., a computer 2002, which is configured to generate a time-temperature curve or profile along the continuously produced gypsum board.

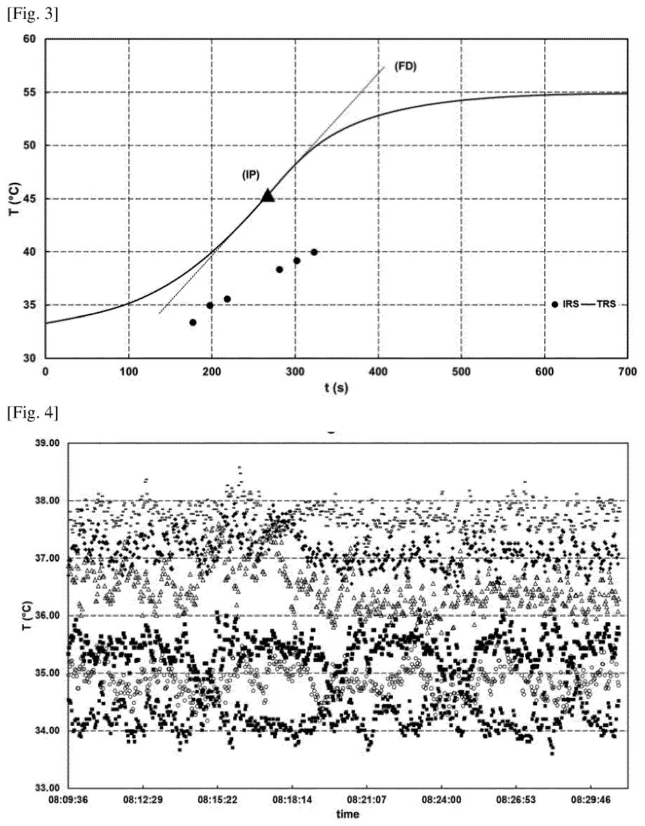

An example of the time-temperature curve (IRS dots) acquired by a series of six infrared sensors between the rolling mill 1012 and the cutting station 1014 is plotted on [FIG. 3]. For comparison the time-temperature curve or profile 3002 from the Temperature Rise Set (TRS line) measured on collected ex-situ samples according to the ASTM C 472 is also represented. Not only the series of infrared sensors 2001a-e may be unable to collect the complete time-temperature curve or profile corresponding to the TRS curve or profile, but also the so measured and generated time-temperature curve may be affected by important offsets; the infrared sensors may indicate that the continuously produced board 1013 is much cooler than what is observed through ex-situ TRS measurements.

Moreover, the region in the vicinity of the inflexion point (IP) of the Temperature Rise Set (TRS) profile is not reproduced correctly by temperature signals from the infrared sensors. Yet, this region is an important feature of the time-temperature profile since it is the point at which the sign of the curvature changes and the slurry may start to set or harden and reach its optimal strength or stiffness for a clean cut.

Furthermore, as exemplified in [FIG. 4] representing the time-temperature signal of each infrared sensors 2001a-e at their respective location along the manufacturing line at the setting stage 1002, the signals from the infrared sensors 2001a-e may be impaired with noise. For each sensor, the standard deviation may vary from 0.4° C. to 0.7° C., which leads to an uncertainty of 4-7% within the 10° C. interval in which the inflexion point (IP) may occur.

As explained earlier, the observed discrepancies between the time-temperature curve as generated through the processing of the signals of the infrared sensors 2001a-d and the reference TRS time-temperature curve or profile may come from different sources, e.g., variations of the temperature of the ambient air surrounding the manufacturing lines, changes in the heat capacity or the thickness of the board (from, e.g., the water content or the nature of the cover sheets), and/or inherent drifts and/or inaccuracies of the infrared sensors.

An important inconvenience is that any attempt to interpolate the full time-temperature curve from the measurements by the infrared sensors may lead to inaccurate estimations of the setting time as it may be done from TRS measurements. This is the reason why current methods for in-line real-time monitor the setting time does not rely on measurements from infrared sensors along the manufacturing line 1000 in the setting stage, but they use them as complement or supplement to measures of physical features, e.g., resistance force or board height, with contact sensors, e.g., force gauges, or optical devices, e.g., lasers.

Therefore, there is still a need for a simple method and system for a real-time, in-line and reliable monitoring of the setting time-temperature profile of a continuously produced gypsum board, which may be suitable for high production throughputs, may not perturb the gypsum board in its hardening/stiffening stage and may be easily implemented on existing manufacturing lines at minimal costs.

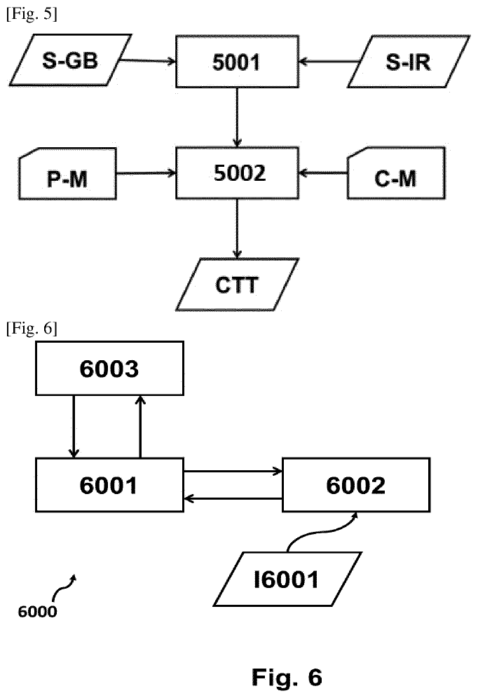

In this regard, with reference to [FIG. 5], in a first aspect of the invention, there is provided a computer implemented method 5000 for in-line, real-time monitoring of the time-temperature profile of a continuously produced gypsum board 1013 in a gypsum board manufacturing line 1000. The method 5000 takes as input the signals S-IR of a series of infrared sensors 2001a-d placed at given distances along the gypsum board manufacturing line between the moulding stage 1001 and the cutting stage 1003 of said gypsum board manufacturing line 1000, and further takes as input the speed S-GB of the continuously produced gypsum board 1013 on the gypsum board manufacturing line 1000. The method 5000 provides as output a corrected time-temperature profile CTT of the continuously produced gypsum board 1013. The method 5000 further comprises the following steps:
(a) converting 5001 the signals of the series of infrared sensors 2001a-d into a time-temperature profile based on the speed S-GB of the continuously produced gypsum board 1013 on the gypsum board manufacturing line 1000;
(b) processing 5002 the time-temperature profile through a correlation model C-M and/or a physical model P-M to calculate a corrected time-temperature profile CTT.

The correlation model C-M is obtained from a mapping between time-temperature profiles acquired by the same series of infrared sensors 2001a-d and time-temperature profiles by ex-situ measurements of Temperature Rise Set on at least one gypsum board which has similar physicochemical features to the continuously produced gypsum board 1013.

The physical model P-M is obtained from a mapping between the heat flow calculated from time-temperature profiles acquired by the same series of infrared sensors 2001a-d and the heat flow calculated from time-temperature profiles by ex-situ measurements of Temperature Rise Set on at least one gypsum board which has similar physicochemical features to the continuously produced gypsum board 1013.

In step (a), the signals of the series of infrared sensors 2001a-d is converted into a time-temperature profile based on the speed S-GB of the continuously produced gypsum board 1013 on the gypsum board manufacturing line 1000. In other words, the acquisition frequency of the infrared sensors may be adjusted so that the sensors acquire temperature signals on the same region of the continuously produced gypsum board as it is conveyed on the manufacturing line in front of each infrared sensor. The adjustment in acquisition frequency may help to reduce the risk of over- or undersampling of the temperature data on the gypsum board.

For instance, if the frequency of acquisition is lower than the inverse of the speed S-GB, the infrared sensors will not acquire signals on the same region of the board as it is conveyed in front of the sensors, and the region of the board on which a temperature signal was acquired by the first sensor may have left the setting stage before the last infrared sensor may acquire a temperature signal on it. A direct drawback is that the acquired temperature signals may then not be representative of the temperature profile of the gypsum board as it conveyed at the setting stage

An example of conversion of the signals of the series of infrared sensors 2001a-d into a time-temperature profile based on the speed S-GB of the continuously produced gypsum board 1013 on the gypsum board manufacturing line 1000 may to adjust the frequency of acquisition of the infrared sensor to the inverse of the speed S-GB of the gypsum board. The acquisition time is then representative to the time scale of the temperature profile of the gypsum board.

The step (b) of processing the time-temperature profile may be performed by using the correlation model C-M and the physical model P-M either alone or in combination, i.e., by using either the correlation model C-M alone, the physical model P-M alone or both one after the other.

According to the invention, both the correlation model C-M and the physical model P-M are obtained from a mapping between time-temperature profiles, or features or parameters thereof, acquired by the series of infrared sensors 2001a-d and by cx-situ measurements of Temperature Rise Set on at least one gypsum board which has similar physicochemical features to the continuously produced gypsum board 1013. Examples of physicochemical features may be the chemical composition of the slurry (e.g., nature of the stucco, water content, accelerator, other additives, foam) and/or the cover sheets of the gypsum board, the thickness of the slurry and/or the cover sheets.

A series of infrared sensors comprises at least two sensors. In certain advantageous embodiments, the input S-IR signals may be signals of at least four, preferably at least six sensors, more preferably at least eight sensors. The greater the number of infrared sensors, the more representative the curvature is of the time-temperature profile generated from the signals of the series of infrared sensors compared to the time-temperature profile from TRS measurements. In particular, the curvature in the region of the inflexion point is more accurate.

In certain embodiments, the correlation model C-M may be a supervised learning algorithm, or a non-supervised learning algorithm trained on a historical database comprising time-temperature profiles from infrared sensors and time-temperature profiles from ex-situ measurements of Temperature Rise Set. The historical database may allow the correlation model C-M to identify correlations between the signals of the series of infrared sensors 2001a-d converted into a time-temperature profile based on the speed S-GB of the continuously produced gypsum board 1013 on the gypsum board manufacturing line 1000 in step (a) with the time-temperature profiles from ex-situ measurements of Temperature Rise Set. Thus, the correlation model C-M may allow obtaining an adjusted value of the IR sensors calculated based on the historical database comprising time-temperature profiles from infrared sensors and time-temperature profiles from ex-situ measurements of Temperature Rise Set.

Examples of correlation model may be linear models, e.g., ridge regression, polynomial regression, decision trees regression, support vector machines regression or ensemble methods, e.g., random forest regression, gradient tree boosting. Artificial neural networks may also be used.

In certain embodiments, the physical model P-M is correction factor calculated from the comparison between the first derivative at the inflexion point of the time-temperature profiles and the first derivative at the inflexion point of the time-temperature profiles from ex-situ measurements of Temperature Rise Set.

In the context of the disclosure, the inflexion point of the time-temperature profiles is the point at which the curvature of said time-temperature profiles change sign and the first derivative is the slope of the line tangent to the curve at a point of interest. As illustrated on FIG. 3, the first derivative at the inflexion point is the slope of the line tangent (FD) to the curve at the inflexion point (IP).

According to the Fourier's law, the first derivative may be considered as representative of the heat flow generated by the exothermic hydration reaction within the slurry. At the inflexion point (IP), since the value of slope of the tangent line (FD) reaches a maximum, this heat flow is maximal, which indicate that the hydration reaction is almost complete, and the board would reach the correct strength or stiffness for a clean cut.

An example of correction factor calculated from the comparison between the first derivative at the inflexion point of the time-temperature profiles and the first derivative at the inflexion point of the time-temperature profiles from ex-situ measurements of Temperature Rise Set may the ratio between said first derivatives, a linear, e.g., polynomial, or non-linear functions thereof.

In certain embodiments, the method may further comprise a step of computing the hydration time from the corrected time-temperature profile CTT. Among other advantages already mentioned, the method according to the first aspect of the invention allows to acquire a time-temperature profile from infrared sensors which is representative of the time-temperature profiles obtained by ex-situ measurements of Temperature Rise Set. Therefore, the corrected time-temperature profile may allow to compute a representative hydration time of the slurry within the continuously produced gypsum board.

Advantageously, the hydration time computed from the corrected time-temperature profile may be the elapsed time from the time corresponding to the lowest temperature before the temperature begins to the time when the maximum temperature rise is attained. The so computed hydration time may then be representative of the hydration time as defined in the section 11 of ASTM C 472 standard.

In certain embodiments, the method may further comprise a step of computing a percent of the hydration time at the cutting stage from the corrected temperature profile (CTT). As explained above, the time when the continuously produced gypsum board 1013 may have the required stiffness or strength for a clean cut at the cutting station 1014 may be equal or shorter than the setting time as defined in the ASTM C 472. As consequence, the hydration level at the time when the continuously produced gypsum board 1013 show that required stiffness or strength for a clean cut may be equal or shorter than the hydration time as the aforementioned standard. This hydration level may be expressed as a percentage of the hydration time at the cutting stage. As example, it may the ratio of the elapsed time when the continuously produced gypsum board 1013 arrive at the cutting stage to the hydration time as computed according to the embodiments described previously.

The first aspect of the invention is computer implemented. Accordingly, with reference to [FIG. 6], in a second aspect of the invention, there is provided a data processing system 6000 comprising means for carrying out a method according to any embodiments of the first aspect of the disclosure.

A first example of means for carrying out the method may be a device 6001 which can be instructed to carry out sequences of arithmetic or logical operations automatically to perform tasks or actions. Such device may comprise one or more Central Processing Unit (CPU) and at least a controller device that are adapted to perform those operations.

The device may further comprise other electronic components like input/output interfaces 6003, non-volatile or volatile storages devices 6002, and buses that are communication systems for the data transfer between components inside a computer, or between computers. One of the input/output devices may be user interface for human-machine interaction, for example graphical user interface to display human understandable information. In this respect, an example of device 6001 may be a computer 2002 as exemplified on [FIG. 2].

An advantage of the method according to the first aspect of the invention is that it may require low computing and data storage resources. A second example of means may then be an on-board system, e.g., low power computer board such as single-board computer, which allows real-time applications.

In a third aspect of the invention, there is provided a computer program 16001 comprising instructions which, when the program is executed by a computer, cause the computer to carry out a method according to any embodiments of the first aspect of the invention.

Any kind of programming language, either compiled or interpreted, can be used to implement the steps of the method of the invention. The computer program can be part of a software solution, i.e., part of a collection of executable instructions, code, scripts or the like and/or databases.

In certain embodiments, the computer program may be stored is on a computer-readable non-transitory medium 6002. Accordingly, such computer-readable nontransitory medium 6002 may comprise instructions which, when executed by a computer, cause the computer to carry out the method according to any of the embodiments described herein.

The computer-readable medium 6002 may be preferably a non-volatile storage or memory, for example a hard disk drive or a flash/non-flash solid-state drive. The computer-readable medium can be removable storage media or a non-removable storage media as part of a computer.

Alternatively, the computer-readable medium 6002 may be a volatile memory inside a removable media. This can case the deployment of the invention into many production sites.

In a fourth aspect of the invention, with reference to [FIG. 2], [FIG. 5] and [FIG. 6], there is a provided a system for real-time and in-line measuring the setting time-temperature profile of a continuously produced gypsum board 1013 in a manufacturing line 1000, wherein said system comprises
a series of infrared sensors 2001a-d placed at given distances along the gypsum board manufacturing line between the moulding stage 1001 and the cutting stage 1003 of said gypsum board manufacturing line 1000,
a processor 2002, 6000 configured to execute a computer program 16001, wherein said computer program 16001 comprises instructions to execute a method according to any embodiments of the first aspect of the invention.

In certain embodiments, the series of infrared sensors 2001a-d may comprise at least 4 sensors, preferably at least 6 sensors, preferably at least 8 sensors, preferably at least 9 sensors, preferably at least 12 sensors, preferably at least 15 sensors. The numbers of infrared sensors may depend on the desired level and/or the possibility of interpolation for the parts of the time-temperature profile which are not acquired by the infrared sensors. As a rule, the greater is the number of infrared sensors, the more representative is the curvature of the time-temperature profile generated from the signals of the series of infrared sensors compared to the time-temperature profile from TRS measurements. Six, preferably eight sensors may be considered as an interesting comprise for accuracy.

In advantageous embodiments, the series of infrared sensors may further comprise at least one, preferably at least two infrared sensors 2003 just after the cutting stage 1003. Additional infrared sensors located after the cutting stage 1003 by providing additional data may help to a better sampling on the time-temperature profile after the inflexion point (IP), and then a better reproduction its curvature. As exemplified on [FIG. 2], the at least one, preferably at least two infrared sensors 2003 may be placed at the exit of the cutting station 1014.

In certain embodiments, the series of infrared sensors 2001a-d, 2003 may be configured so that said infrared sensors 2001a-d, 2003 are spaced distance along the gypsum board manufacturing line by the speed of the continuously produced gypsum board on the manufacturing line multiplied by 60 seconds or less, preferably 40 seconds or less, more preferably 30 seconds or less. Such arrangement may provide a valuable sampling of the time-temperature profile along the continuously produced gypsum board.

In certain embodiments, the series of infrared sensors 2001a-d may be configured so that the infrared sensors are placed less than 1 meter, preferably less than 0.5 m from the gypsum board surface.

According to the whole disclosure, the system of the fourth aspect of the invention may be advantageously used in a manufacturing line 1000 of profile of a continuously produced gypsum board 1013. In advantageous embodiments, the system may be either implemented as a control system for monitoring the time-temperature profiles of a continuously produced gypsum board 1013 or as a feedback control system for controlling the hydration level of a continuously produced gypsum board 1013

Accordingly, in a fifth aspect of the invention, there is provided a feedback control system for the hydration of a continuously produced gypsum board 1013 in a manufacturing line (1000), wherein said feedback system comprises:
a system according to any of the embodiments of the fourth aspect of the invention;
a control device configured to adjust the line speed between the moulding stage 1001 and the cutting stage 1003 of the manufacturing line 1000, and/or the level of setting accelerator within the slurry, so as to maintain a certain level of hydration of the gypsum board between the moulding stage 1001 and the cutting stage 1003, and/or during the cutting stage 1002, based on a percentage of hydration time calculated from the corrected setting time-temperature profile for at least one location between the moulding stage 1001 and the cutting stage 1003.

In an advantageous embodiment, the percentage of hydration time is calculated at the cutting stage 1003.

All embodiments from the first to the fifth aspect of the invention described in the present disclosure may be combined by one skilled in the art unless they appear to him technically incompatible.

### EXAMPLES

In an illustrative example, 14 infrared sensors were placed at given distances between the moulding stage and the cutting stage of a gypsum board manufacturing line which is continuously producing a gypsum board at a production speed of 37 m·min⁻¹. The temperature of the gypsum is acquired continuously at regular interval with a frequency corresponding to the inverse of speed of the gypsum board.

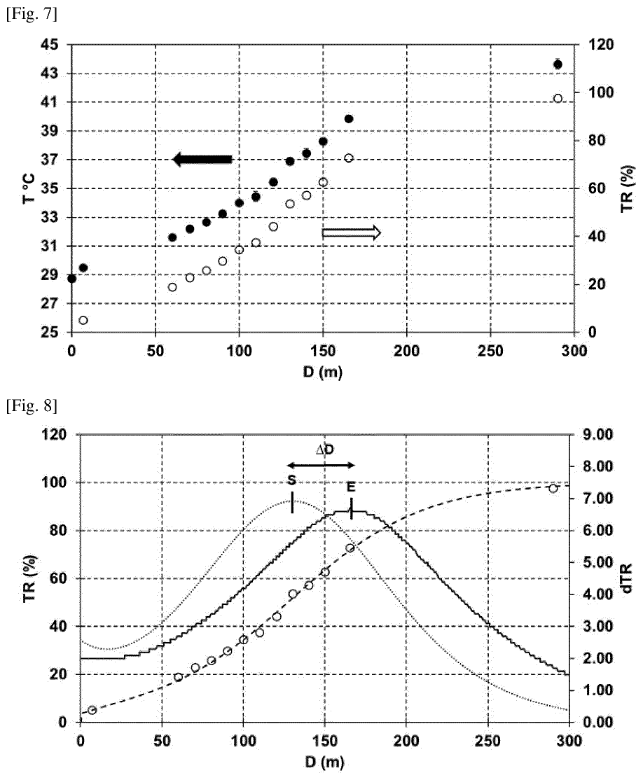

FIG. 7 is a plot of the temperature, T, (filled circles, left vertical axis) acquired by each infrared sensors in function of the distance, D, from the moulding stage. The acquisition error is about the size of the symbols. For sake of simplicity and illustration, on [FIG. 7], the temperature profile is represented as a function of the distance but may be equivalently represented as a function of time by multiplying the distance by the board speed.

An equivalent but maybe more illustrative way to represent the acquired temperatures is to convert them into relative temperature rise rates, TR, also plotted (open circles, right vertical axis) on [FIG. 7]. This conversion may be performed with the following formula:

$$TR = \frac{T - {T}_{min}}{{T}_{max} - {T}_{min}} \times 100$$

Where T is the currently acquired temperature by a given infrared sensor, and Tmin and Tmax are respectively the minimum and the maximum temperatures that are acquired by all the infrared sensors. Using temperature rise rates, TR, instead of temperatures, T, is to get rid of relative temperature variation which may come from the surrounding environment of the manufacturing lines.

The acquired temperature rates, TR, are then modelled with a parametrized sigmoid function according to the following formula and the parameters listed in Table 1.

$$F = G \cdot \frac{1 - {e}^{- {( k \cdot t )}^{n}}}{1 + {e}^{( t - a ) / b}} + C$$

Where t is time, and a, b, k, n, G and C are fitting parameters.

TABLE 1

| a | b | k | n | G | C |
|---|---|---|---|---|---|
| 211 | 65 | 0.038 | 1 | 29.9 | 29.8 |

The fitted data (open circles, left vertical axis) and the parametrized fitting sigmoid function (dashed line, left vertical axis) are plotted on [FIG. 8]. Is also plotted the first derivative (dotted line, right vertical axis) of the fitting sigmoid function. This first derivative is representative of the heat flow and shows a maximum, S, at the inflexion point of the fitting sigmoid function at the distance of about 133 m.

On [FIG. 8], is also plotted the first derivative (solid line) of a time-temperature profile—here converted into temperate rate, TR,—distance, D, profile—obtained from an ex-situ measurement of Temperature Rise Set performed on gypsum slurry sampled just before the moulding stage. This first derivative is representative of the heat flow of the sample during setting. It shows a maximum, E, at the inflexion point of the fitting sigmoid function at the distance of about 167 m. The sampling of slurry and the ex-situ measurement of Temperature Rise Set may be performed at regular interval, e.g., every two hours, to anticipate any deviation because of, e.g., changes in the operating parameters of the manufacturing line and/or in the chemistry, i.e., composition of the slurry.

As illustrated on [FIG. 8], the two maxima S and E of the first derivatives (dotted and solid lines) does not coincide but are separated from each other by a distance, AD, of about 34 m. This discrepancy shows that the infrared sensors are not calibrated and cannot monitor accurately the temperature of the continuously produced gypsum board.

A first but very simple correlation model for correcting the acquired temperature rate may be an offsetting affine function which offsets the temperature rates, TR, by a value of ΔD=+34 m. Said affine function may be expressed with the following formula:

$${TR}_{corr} = {TR}_{meas} + Δ D$$

Where TRcorr is the corrected temperature rate, TRmeas is the temperature rate as measured by the infrared sensors and ΔD is the offset factor, e.g., here +34.

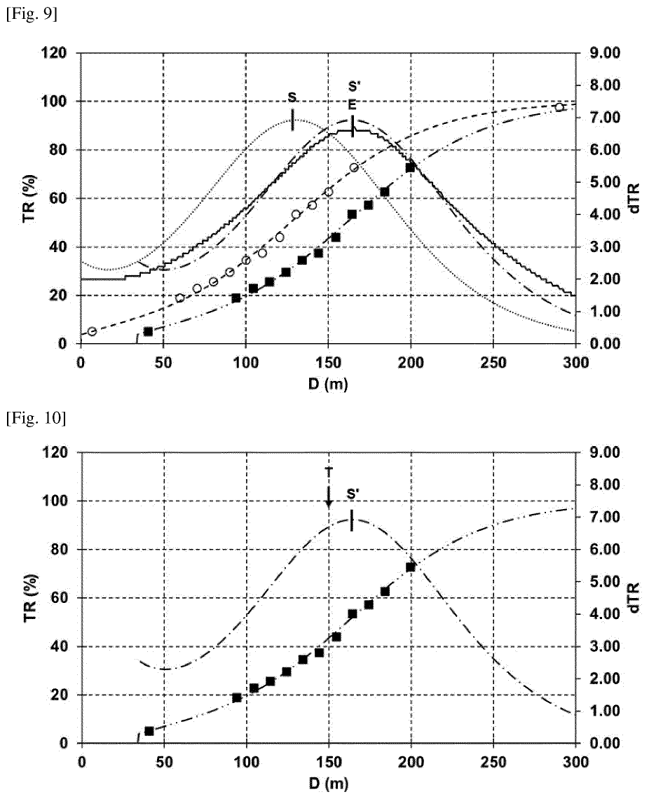

A correction with this simple offsetting affine function is illustrated on [FIG. 9]. Are plotted the corrected temperature rates (filled squares, left vertical axis), the corrected fitting sigmoid function (dot-dot-dashed line) and the corrected first derivative (dotted line, right vertical axis) of the fitting sigmoid function (dot-dashed line, right vertical axis).

As further illustrated on [FIG. 9], with the correction, the maximum S′ of the corrected first derivative (dot-dashed line, right vertical axis) of the fitting sigmoid function now coincides with the maximum E of the first derivative (solid line) of the time-temperature profile obtained from an ex-situ measurement of Temperature Rise Set.

Although such correction may be satisfactory for some practical cases, it may however not be efficient in other cases, in particular, when the general trend in temperatures measured by the infrared sensors does not follow a sigmoid or a sigmoid-like curve. The shape of the first derivative may then strongly depart from the first derivative of a time-temperature profile obtained from an ex-situ measurement of Temperature Rise Set. A more sophisticated correlation model may then be required.

An example of more sophisticated correlation, which however not be fully detailed here, may be based on a fitting function which reproduces the first derivative of a time-temperature profile obtained from an ex-situ measurement of Temperature Rise Set, and which may then be subject to a mathematical integration to rebuild time-temperature profile from which individual correction factors may be derived for each infrared sensor.

In the present illustrative example, besides the offset correction, a better correction may further be contemplated for a best monitoring of the temperature rates, TR, by the infrared sensors, so that they may be used, e.g., as quick proxy for the Temperature Rise Set of the slurry. On [FIG. 9], the corrected first derivative (dot-dashed line, right vertical axis) of the fitting sigmoid function and the first derivative (solid line) of the time-temperature profile obtained from an ex-situ measurement of Temperature Rise Set does not superpose perfectly in their shape or curvature. A sophisticated correlation model as briefly exposed above may be advantageously implemented for such objective.

According to some aspects of the invention, the monitoring of the time-temperature profile of a continuously produced gypsum board may be used in a feedback control system. An example of use is illustrated on [FIG. 10]. A targeted hydration time, T, is represented by black arrow at a distance of about 150 m, which corresponds to the location required for 50% of the hydration time of the gypsum board to reach 60% of the hydration time at the cutting stage for a clean cut.

To reach the target, T, the maximum S′ of the corrected first derivative (dot-dashed line, right vertical axis) of the fitting sigmoid function should be located at 150 m, not at about 167 m onward. Among several remedies to shift the maximum S′ to the target T, adjusting the dyer power, the line speed and/or the content of setting accelerator within the slurry may be valuable.

Although the invention has been described in connection with preferred embodiments and examples, it should be understood that various modifications, additions, and alterations may be made to the invention by one skilled in the art without departing from the spirit and scope of the invention as defined in claims.

### PATENT LITERATURE

U.S. Pat. No. 4,496,515 A [UNITED STATES GYPSUM CO [US]] 29 Jan. 1985.
US2004052297 A1 [RAYTEK [US]] 18 Mar. 2004
WO 2017078952 A1 [UNITED STATES GYPSUM CO [US]] 11 May 2017.
CN 110757645 A [BEIJING NEW BUILDING MAT PLC] 7 Feb. 2020.
US2017363524 A1 [UNITED STATES GYPSUM CO [US]] 9 Jun. 2020.

### Non-Patent Literature

Standard Test Methods for Physical Testing of Gypsum, Gypsum Plasters and Gypsum Concrete, ASTM C 472-99, American society for testing and materials.

1. A computer implemented method for in-line, realtime monitoring of the time-temperature profile of a continuously produced gypsum board in a gypsum board manufacturing line;
wherein the method takes as input signals of a series of infrared sensors placed at given distances along the gypsum board manufacturing line between a moulding stage and a cutting stage of said gypsum board manufacturing line, and further takes as input a speed of the continuously produced gypsum board on the gypsum board manufacturing line;
wherein the method provides as output a corrected time-temperature profile of the continuously produced gypsum board, the method further comprises the following steps:
(a) converting the signals of the series of infrared sensors into a time-temperature profile based on the speed of the continuously produced gypsum board on the gypsum board manufacturing line;
(b) processing the time-temperature profile through a correlation model and/or a physical model to calculate a corrected time-temperature profile;
wherein the correlation model is obtained from a mapping between time-temperature profiles acquired by the same series of infrared sensors and time-temperature profiles by ex-situ measurements of Temperature Rise Set on at least one gypsum board which has similar physicochemical features to the continuously produced gypsum board;
wherein the physical model is obtained from a mapping between a heat flow calculated from time-temperature profiles acquired by the same series of infrared sensors and a heat flow calculated from time-temperature profiles by ex-situ measurements of Temperature Rise Set on at least one gypsum board which has similar physicochemical features to the continuously produced gypsum board.

2. The method according to claim 1, wherein the correlation model may be a supervised learning algorithm, or a non-supervised learning algorithm trained on a historical database comprising time-temperature profiles from infrared sensors and time-temperature profiles from ex-situ measurements of Temperature Rise Set.

3. The method according to claim 1, wherein the physical model is correction factor calculated from the comparison between the first derivative at the inflexion point of the time-temperature profiles and the first derivative at the inflexion point of the time-temperature profiles from ex-situ measurements of Temperature Rise Set.

4. The method according to claim 1, wherein said method may further comprise a step of computing a hydration time from the corrected time-temperature profile.

5. The method according to claim 1, wherein said method may further comprise a step of computing a percent of a hydration time at the cutting stage from the corrected temperature profile.

6. A data processing system comprising means for carrying out a method according to claim 1.

7. A non-transitory computer program comprising instructions which, when the program is executed by a computer, causes the computer to carry out a method according to claim 1.

8. A system for real-time and in-line measuring the setting time-temperature profile of a continuously produced gypsum board in a manufacturing line, wherein said system comprises;
a series of infrared sensors placed at given distances along the gypsum board manufacturing line between the moulding stage and the cutting stage of said gypsum board manufacturing line,
a processor configured to execute a computer program, wherein said computer program comprises instructions to execute a method according to claim 1.

9. The system according to claim 8, the series of infrared sensors comprises at least 4 sensors.

10. The system according to claim 8, wherein the series of infrared sensors further comprises at least one infrared sensor just after the cutting stage.

11. The system according to claim 8, wherein the series of infrared sensors is configured so that said infrared sensors are spaced distance along the gypsum board manufacturing line between each infrared sensor is the speed of the continuously produced gypsum board on the manufacturing line multiplied by 60 seconds or less.

12. The system according to claim 8, wherein the series of infrared sensors are configured so that the infrared sensors are placed less than 1 meter from the gypsum board surface.

13. A method comprising providing a system according to claim 8 in a manufacturing line of a continuously produced gypsum board.

14. A feedback control system for hydration of a continuously produced gypsum board in a manufacturing line, wherein said feedback system comprises:
a system according to claim 8;
a control device configured to adjust the line speed between the moulding stage and the cutting stage of the manufacturing line, and/or the level of setting accelerator within the slurry, so as to maintain a certain level of hydration of the gypsum board between the moulding stage and the cutting stage, and/or during the cutting stage, based on a percentage of hydration time calculated from the corrected setting time-temperature profile for at least one location between the moulding stage and the cutting stage.

15. The feedback control system according to claim 14, wherein the percentage of hydration time is calculated at the cutting stage.

16. The system according to claim 9, the series of infrared sensors comprises at least 6 sensors.

17. The system according to claim 16, the series of infrared sensors comprises at least 8 sensors.

18. The system according to claim 10, wherein the series of infrared sensors further comprises at least two infrared sensors just after the cutting stage.

19. The system according to claim 11, wherein the series of infrared sensors is configured so that said infrared sensors are spaced distance along the gypsum board manufacturing line between each infrared sensor is the speed of the continuously produced gypsum board on the manufacturing line multiplied by 40 seconds or less.

20. The system according to claim 12, wherein the series of infrared sensors are configured so that the infrared sensors are placed less than 0.5 m from the gypsum board surface.
